(19) United States
(12) Patent Application Publication
(10) Pub. No.: US 2013/0176614 A1
(43) Pub. Date: Jul. 11, 2013

(54) EUV COLLECTOR MIRROR SHELL OF AN EUV COLLECTOR FOR EUV LITHOGRAPHY

(71) Applicant: Carl Zeiss Laser Optics GmbH, Oberkochen (DE)

(72) Inventors: Willi Anderl, Huettlingen (DE); Holger Kierey, Aalen (DE); Markus Bauer, Oberkochen (DE); Jens Kugler, Aalen (DE)

(73) Assignee: CARL ZEISS LASER OPTICS GMBH, Oberkochen (DE)

(21) Appl. No.: 13/753,127

(22) Filed: Jan. 29, 2013

Related U.S. Application Data
(63) Continuation of application No. PCT/EP2011/063700, filed on Aug. 9, 2011.
(60) Provisional application No. 61/372,529, filed on Aug. 11, 2010.

(30) Foreign Application Priority Data
Aug. 11, 2010 (DE) 102010034476.1

(51) Int. Cl. G02B 5/08

(52) U.S. Cl. CPC G02B 5/0891
USPC 359/350

(57) ABSTRACT

An EUV collector mirror shell of an EUV collector for EUV lithography includes a body which has a light incidence-side front part having a reflective optically active area, a rear part, and a cavity between the front and rear parts. The cavity extends essentially along the entire optically active area, and the cavity serves to receive a cooling medium. The body also has at least one inlet and at least one outlet for the cooling medium. A plurality of flow-influencing elements are in the cavity, extending from the front part to the rear part, and connecting the front part to the rear part and monolithically formed with the front and rear parts.

### CROSS-REFERENCE TO RELATED APPLICATIONS

The present application is a continuation of, and claims benefit under 35 USC 120 to, international application PCT/EP2011/063700, filed Aug. 9, 2011, which claims benefit under 35 USC 119 of German Application No. DE 10 2010 034 476.1, filed Aug. 11, 2010 and under 35 USC 119(e) of U.S. Ser. No. 61/372,529, filed Aug. 11, 2010. International application PCT/EP2011/063700 incorporates by reference DE 10 2010 034 476.1 and U.S. Ser. No. 61/372,529. The entire disclosure of each of these applications is incorporated by reference herein.

### FIELD

The disclosure relates to an EUV collector mirror shell of an EUV collector for EUV lithography, including a body which has a light incidence-side front part, having a reflective optically active area, and a rear part, and which has a cavity between the front part and the rear part, the cavity extending essentially along the entire optically active area, and the cavity serving for receiving a cooling medium, the body having, furthermore, at least one inlet and at least one outlet for the cooling medium.

### BACKGROUND

A mirror shell of an EUV collector is known from WO 2007/051638 A1.

In EUV lithography, light in the extreme ultraviolet (EUV) spectral range, for example light of a wavelength of 13 nm, is used in order to image a reticle onto a wafer.

When an optical EUV system is in operation, the mirror shell may heat up to a considerable extent. Light incident onto the reflective optically active area is partially absorbed by the optically active area. Absorption generates heat which is propagated into the body of the mirror shell.

Various problems arise due to the heating-up of the mirror shell during operation. A first problem may be that the mirror shell becomes too hot, with the result that the substrate material of the optically active area and the optical layers provided on it can be destroyed.

A further problem caused by the heating-up of the mirror shell is that it is deformed, so the optical capacity of the collector no longer conforms to the specification.

Moreover, the deformation of the mirror shell optical element may vary during operation (what are known as transient effects). A once-only (static) correction of the imaging error occurring in the optical system, for example with the aid of other optical elements, is therefore usually not sufficient.

Particularly in the case of applications in EUV systems, the mirror shell is subjected to high thermal stress, because the EUV collector captures the light radiation of the light source and absorbs a large amount of infrared light.

In order to solve the problems mentioned above, which arise due to the heating-up of an optical element, like the mirror shell, cooling concepts were developed in order to discharge the heat which occurs in the optical element during operation.

The known cooling concepts predominantly involve integrating in the otherwise solid body of the optical element individual cooling ducts or cooling lines through which a cooling medium is conducted. Optical elements with this type of cooling are disclosed in U.S. Pat. No. 6,822,251 B1; US 2007/0084461 A1; US 2005/0099611 A1; US 2005/012846 A1; US 2006/0227826 A1 and U.S. Pat. No. 7,329,014 B2.

Cooling an optical element via cooling ducts or cooling lines has the advantage that the cooling ducts or cooling lines predetermine a specific flow direction, with the result that the cooling system can therefore be calculated more easily. However, the disadvantage of this type of cooling is that the structure of the ducts or lines embosses on the optically active area of the optical element when the optical element heats up and the regions of the optically active area between the cooling ducts or cooling lines become hotter than the regions which are directly adjacent to the respective cooling duct or respective cooling line.

The abovementioned disadvantages can be avoided if the optical element has in its body, instead of individual cooling ducts or cooling lines, a large-area cavity which extends essentially along the entire optically active area. Such a type of cooling is described in the initially mentioned document WO 2007/051638 A1 in FIGS. 16 to 19 of the latter. Providing a large-area cavity at a short distance from the optically active area of the optical element has the advantage that the cooling medium reaches essentially the entire optically active area. A disadvantage which nevertheless became apparent was that the cooling medium does not flow uniformly through the cavity between the at least one inlet and the at least one outlet for the cooling medium, that is to say, in the cavity, there are regions with good throughflow and therefore good heat dissipation and regions with poor throughflow and therefore poor heat dissipation. The result is that, on account of different flow conditions in the cavity, thermal gradients arise in the optically active area and may lead to undesirable deformation of the optical element. A further disadvantage of the known mirror shell is that even the pressure of the cooling medium in the large-area cavity may lead to the deformation of the mirror shell.

U.S. Pat. No. 4,844,603 discloses a mirror arrangement having a flexible face plate having a reflective surface and a flexible backing plate with a gap in between. An array of elongated actuators is arranged on a support rearwardly of and perpendicular to the backing plate. The gap is sealed with respect to the carrier of the mirror arrangement to form an enclosed cooling chamber. A cooling fluid is supplied to the cooling chamber through supply pipes and discharged therefrom through discharge pipes that are fixed to the support and arranged between the actuators and communicate with the cooling chamber through respective inlet and outlet openings that are provided in the backing plate.

U.S. Pat. No. 5,209,291 discloses an internally-cooled optical device which includes a manifold having two oppositely disposed coolant input ports and two oppositely disposed coolant output ports. The input coolant flow is divided into macro-channels, with each macro-channel having an associate plurality of micro-channels for carrying the coolant along a surface juxtaposed with the surface of the optical device face plate.

DE 100 52 249 A1 discloses a deformable mirror used as a laser beam guidance component, including a housing to which is assigned a mirror element, wherein the mirror element is deformable and can be cooled by a cooling medium. The cooling medium is guided through a plurality of cooling ducts.

U.S. Pat. No. 4,657,358 discloses a cooled deformable mirror having one or more enclosed spaces within the mirror's face plate which are supplied with a coolant through one or more actuators used to deform the mirror surface, and one or more other of the actuators are used to remove the coolant from the mirror face plate. In one embodiment, a coolant distribution manifold is arranged in the face plate to facilitate the distribution of coolant within the face plate after the coolant has been delivered to the face plate by apertures in one or more of the actuators.

U.S. Pat. No. 4,770,521 discloses a cooled laser mirror with a mirror surface, a forced-convective cooling heat exchanger, and a substrate. The laser mirror includes a monolithic substrate isolator of porous isotropic material having transpiration flow paths therethrough for providing transpiration cooling of the isolator.

U.S. Pat. No. 3,923,383 discloses a fluid-cooled laser mirror including a body defining an internal chamber, a fluid inlet port mechanism adjacent the center of the body, and a fluid outlet port mechanism adjacent to the peripheral edge of the body. A plurality of radially positioned interleaved ribs or vanes are included for directing fluid from the inlet port mechanism to the outlet port mechanism in a continuous, generally directly outward manner. The positioning of the vanes provides a degree of turbulence in such flowing fluid.

### SUMMARY

The disclosure provides and EUV collector mirror shell of an EUV collector for EUV lithography such that uniform cooling of the mirror shell is achieved.

In one aspect, the disclosure provides an EUV collector mirror shell having a plurality of flow-influencing elements arranged in a cavity, extending from a front part to a rear part, and connecting the front part to the rear part and which are formed in one piece with the front part and with the rear part.

The present disclosure is based on the concept of providing the body of the mirror shell with a large-area cavity which is filled with a cooling medium to be conducted through the cavity between the at least one inlet and the at least one outlet. According to the disclosure, a plurality of, preferably many flow-influencing elements are arranged in the cavity and extend from the front part of the body to its rear part. The flow-influencing elements in each case give rise at their location to a local deflection of the flow of cooling medium, with the result that the cooling medium flows substantially more uniformly through the cavity. As a result, regions with poor throughflow, that is to say dead zones in the cavity, in which the cooling medium is stationary or flows only slightly, are at least reduced. Since the flow-influencing elements extend from the front part to the rear part and connect the front part to the rear part and are monolithically formed with the front part and with the rear part, i.e. they are formed in one piece with the front part and with the rear part, the above-described disadvantage that the mirror shell bends on account of the pressure of the cooling medium in the cavity is likewise reduced or even eliminated.

The flow-influencing elements provided according to the disclosure are preferably designed as posts or pins or baffle-like elements having a small cross section of any desired shape. Furthermore, it is preferable if the flow-influencing elements are heat-conductive. The flow-influencing elements, in the sense of a one piece configuration, may be integrated into the front part and/or the rear part.

In a preferred refinement, the distribution, size and/or shape of the flow-influencing elements in the cavity are selected as a function of the position of the at least one inlet and the position of the at least one outlet, such that the cooling medium flows essentially uniformly through the entire cavity.

The distribution of the flow-influencing elements is selected such that the cooling medium, when it flows through the cavity, impinges constantly onto a flow-influencing element, with the result that local changes in the flow direction of the cooling medium are brought about and the cavity thus has a uniform throughflow, so that the cooling medium can efficiently absorb and dissipate the heat on the wall of the cavity and on the flow-influencing elements. A constant intermixing of the cooling medium therefore also takes place, so that virtually no different temperature ranges throughout the cavity occur in the cooling medium. The flow of cooling medium can also be influenced with the effect of good heat dissipation by a suitable choice of the size and/or shape of the flow-influencing elements.

In a further preferred refinement, the at least one inlet is arranged at an inner margin, facing the middle of the body, of the cavity, and the at least one outlet is arranged at an outer margin, facing away from the middle of the body, of the cavity, or vice versa.

In this refinement, the basic flow of cooling medium in the cavity is directed essentially from the centre of the cavity to the periphery of the cavity, or vice versa. In this case, preferably, there may also be provision for the flow-influencing elements to be distributed such that an azimuthal flow of cooling medium occurs in the centre of the cavity and on the periphery of the cavity, that is to say a flow of cooling medium in the circumferential direction about an axis perpendicular to the optically active area of the mirror shell.

In connection with the abovementioned measure whereby the at least one inlet is arranged approximately in a middle of the cavity and the at least one outlet is arranged at an outer margin of the cavity, or vice versa, it is preferable, furthermore, if the distribution of the flow-influencing elements in a region of the cavity which corresponds to the shortest path from the at least one inlet to the at least one outlet has a higher density than in the remaining region of the cavity.

This measure has the effect that the cooling medium is prevented from flowing from the at least one inlet along the shortest path to the at least one outlet, because the higher density of distribution in this region of the shortest path causes a greater deflection of the cooling medium into the remaining regions of the cavity. This measure, too, advantageously contributes to an especially uniform throughflow of cooling medium through the cavity.

It will be appreciated that a plurality of inlets and outlets into and out of the cavity may be present, and the distribution of the flow-influencing elements is preferably adapted to the plurality of inlets and outlets.

In a further preferred refinement, the at least one inlet and the at least one outlet are arranged at an outer margin, facing away from the middle of the body, of the cavity.

In this version, therefore, the at least one inlet and the at least one outlet are located on the periphery of the cavity. The basic flow of cooling medium is therefore not “star-shaped” from the centre to the periphery, and vice versa, but instead, the basic flow of cooling medium runs from periphery to periphery in this refinement. In this case, too, the distribution of the flow-influencing elements is appropriately adapted with the effect of as uniform a throughflow of a cooling medium through the cavity as possible.

In a development of the abovementioned measure, the at least one inlet and the at least one outlet are arranged in mutually opposite positions at the outer margin of the cavity.

It is advantageous in this case that the cooling medium has to flow diametrically through the cavity from the inlet to the outlet in the basic flow direction, the flow-influencing elements having the effect that the cooling medium does not pass from the inlet to the outlet along the shortest path, but essentially into all the regions of the cavity, so that dead zones where there is a lack of flow of the cooling medium are at least greatly reduced.

Another development of the abovementioned design provides for the at least one inlet to be assigned at least two outlets which are arranged in positions at the outer margin of the cavity which are not opposite to the position of the at least one inlet.

In this refinement, for example, two inlets may be arranged diametrically to one another at the outer margin of the cavity and two outlets diametrically to one another at the outer margin of the cavity, which are offset, for example at 90°, with respect to the inlets, or more than two inlets and more than two outlets may be provided, distributed over the outer margin, that is to say around the periphery of the cavity.

The advantage of this measure is that the basic flow of cooling medium in the cavity can easily reach the peripheral region of the cavity.

In a further preferred refinement, the cavity has, in a middle of the area of the optically active area, a region through which the cooling medium does not flow.

This refinement is advantageous particularly when the at least one inlet and/or the at least one outlet are/is arranged in the centre of the cavity, because a dead zone in the flow of cooling medium in the centre of the cavity is thereby avoided and an azimuthal flow of cooling medium in the centre of the cavity is assisted.

In a further preferred refinement, the cavity is subdivided into a plurality of segments which are separated completely from one another by webs which extend from the rear part to the front part, each segment having at least one inlet and at least one outlet for the cooling medium.

For example, the cavity may be subdivided into four segments. In this refinement, although a plurality of inlets and a plurality of outlets are used according to the number of segments, for example four inlets and four outlets in the case of four segments, this measure nevertheless has the advantage that the regions of the cavity through which the cooling medium flows do not penetrate one another and lead to disturbances in the flow of cooling medium or to disturbances of the thermal behaviour.

In a further preferred refinement, the at least one inlet opens out into an inlet distributor duct and/or the at least one outlet opens out into an outlet distributor duct, the inlet distributor duct and/or the outlet distributor duct opening out into the cavity, the inlet distributor duct and/or the outlet distributor duct extending azimuthally with respect to a longitudinal axis running perpendicularly to the optically active area.

It is in this case advantageous that the inlet distributor duct and/or the outlet distributor duct cause/causes a defined azimuthally uniform throughflow of the cavity.

In connection with the abovementioned measure, it is preferable, furthermore, if the inlet distributor duct and/or the outlet distributor duct are/is arranged on a side of the rear part which faces away from the cavity.

It is advantageous in this case that the cavity can extend virtually along the entire optically active area. This would not be so if the inlet distributor duct and/or the outlet distributor duct were arranged directly next to the cavity or directly beneath the front part. Moreover, in the latter case, cooling in these marginal regions of the optically active area would not be very effective, because the flow velocity of the cooling medium in these regions is somewhat low on account of the large cross section and therefore the cooling action would likewise be low.

In a further preferred refinement of the abovementioned measures, the inlet distributor duct and/or the outlet distributor duct open out/opens out into the cavity via a narrow gap extending over the length of the inlet distributor duct and/or outlet distributor duct in the azimuthal direction about the longitudinal axis, or via a plurality of small orifices.

This measure has the advantage that the gap or gaps or the plurality of small orifices ensure an azimuthally uniform throughflow of the cavity, to be precise in that the cooling medium is impounded in the inlet distributor duct or outlet distributor duct.

In a further preferred refinement, the cross section of the inlet distributor duct and/or the cross section of the outlet distributor duct change/changes, starting from the inlet or the outlet respectively, with the cross section in particular tapering.

This measure has the advantage that the uniform distribution of the cooling medium in the inlet distributor duct or the uniform collection of the cooling medium in the outlet distributor duct is improved even further.

The abovementioned inlet distributor duct and outlet distributor duct may consist of the same material as the front part and rear part of the body of the mirror shell.

In a further preferred refinement, the flow-influencing elements have in cross section a shape which causes eddying in the flow of the cooling medium.

The advantage of generating eddies in the flow of cooling medium due to the flow-influencing elements is that such eddies are advantageous for a good heat dissipation. The basic flow of cooling medium in the cavity may in this case be laminar, but, even in the case of a turbulent basic flow, affords better heat dissipation.

In one embodiment of this refinement, the flow-influencing elements are round in cross section and/or have an elongate shape in cross section, in the latter case the flow-influencing elements having a longitudinal extent non-parallel, in particular transverse or oblique, with respect to the flow direction of the cooling medium.

Flow-influencing elements of round cross section can generate eddies in the flow of cooling medium both on the upstream side and on the downstream side of the respective flow-influencing element. The advantage of a round shape is, inter alia, that the flow-influencing elements can easily be produced as geometrically simple parts. In a refinement of the flow-influencing elements having a shape elongating cross section, similar to baffle plates, there is the advantage that, by an appropriate orientation of these flow-influencing elements of elongate cross section with respect to the flow direction of the cooling medium, eddying and heat dissipation can be set in suitable way in relation to the routing of the cooling medium through the cavity. The more the elongate flow-influencing elements are arranged parallel to the flow direction of the cooling medium, the less eddying occurs, where at the same time the routing of the cooling medium through the cavity is improved. If the elongate flow-influencing elements are oriented obliquely or transversely with respect to the flow direction of the cooling medium, eddying and heat dissipation are intensified, whereas the routing of the cooling medium through the cavity is reduced.

Since excessive eddying on account of a, for example, round cross-sectional shape of the flow-influencing elements may lead to an increased pressure loss in the flow of cooling medium and also to the excitation of vibrations in the mirror shell, in a further preferred refinement there is provision for the flow-influencing elements to have in cross section a shape which causes eddying of the flow of cooling medium only on that side of the respective flow-influencing element which faces away from the local flow direction.

This refinement constitutes an advantageous compromise of a lower pressure loss in the flow of cooling medium and of reduced excitation of vibrations, on the one hand, and good heat dissipation, on the other hand.

In one embodiment of this refinement, the flow-influencing elements are of drop-shaped form in cross section.

However, the flow-influencing elements may also have in cross section a shape which is streamlined.

The flow-influencing elements having a shape which is streamlined in cross section have the effect that no or essentially no eddies are formed in the flow of cooling medium, and corresponding pressure losses and excitations of vibrations caused by the flow of cooling medium are avoided.

It will be appreciated that not only one type of flow-influencing elements, that is to say flow-influencing elements of identical shape, may be arranged in the cavity, but flow-influencing elements with different cross-sectional shapes, for example of the types described above, may also be present in the cavity.

The cross-sectional size of the flow-influencing elements may also be different throughout the cavity.

In a preferred refinement, there is provision, in this connection, for the flow-influencing elements to have a differing, in particular increasing cross-sectional size from a middle towards the outer margin of the cavity.

Further advantages and features may be gathered from the following description and the accompanying drawing.

It will be appreciated that the abovementioned features and those yet to be explained below can be used not only in the combination specified in each case, but also in other combinations or alone, without departing from the scope of the present disclosure.

### BRIEF DESCRIPTION OF THE DRAWINGS

Exemplary embodiments of the disclosure are illustrated in the drawings and are described in more detail below with reference to this. In the drawings:

FIG. 1a) and b) show an optical element in form of an EUV collector mirror shell according to a first exemplary embodiment, FIG. 1a) showing the optical element partially in longitudinal section in a plane parallel to an axis A, and FIG. 1b) showing the optical element in a top view, in FIG. 1b) a front part of the optical element being partially cut away;

FIG. 2a) and b) show an optical element in form of an EUV collector mirror shell according to a further exemplary embodiment, FIG. 2a) showing the optical element in longitudinal section in a plane parallel to an axis A, and FIG. 2b) showing the optical element in a top view, with a front part of the optical element being omitted;

FIG. 3 shows an optical element in form of an EUV collector mirror shell according to a further exemplary embodiment, in a top view, with a front part of the optical element being omitted;

FIG. 4 shows an optical element in form of an EUV collector mirror shell according to a further exemplary embodiment in a top view, with a front part of the optical element being omitted;

FIG. 5 shows an optical element in form of an EUV collector mirror shell according to a further exemplary embodiment in a top view, a front part of the optical element being partially cut away;

FIG. 6 shows a detail of an optical element in form of an EUV collector mirror shell according to a further exemplary embodiment, in longitudinal section in a plane parallel to an axis A;

FIG. 7 shows a further detail of the exemplary embodiment in FIG. 6;

FIG. 8a) and b) show further details of the optical elements in FIGS. 1 to 7, FIG. 8a) showing a detail from an arrangement of flow-influencing elements, and FIG. 8b) showing a single flow-influencing element from FIG. 8a);

FIG. 9a) to c) show further details of the optical elements in FIGS. 1 to 7, in exemplary embodiments modified with respect to FIG. 8a) and b), FIG. 9a) showing a detail from an arrangement of flow-influencing elements, and FIG. 9b) and c) show in each case a single flow-influencing element in two design variants;

FIG. 10a) to c) shows further details of the optical elements in FIGS. 1 to 7 in exemplary embodiments modified with respect to FIGS. 8 and 9, FIG. 10a) showing a first variant, FIG. 10b) a second variant and FIG. 10c) a third variant of a detail from an arrangement of flow-influencing elements;

FIG. 11 shows an illustration of a detail of an optical element in form of an EUV collector mirror shell according to a further exemplary embodiment; and

FIG. 12 shows a further arrangement of flow-influencing elements in a cavity of an optical element in form of an EUV collector mirror shell according to yet another exemplary embodiment.

### DETAILED DESCRIPTION

What are described below with reference to the figures are optical elements in the form of EUV collector mirror shells of EUV collectors and details of these optical elements, which can be used, in particular, in optical systems for EUV applications. The following description relates particularly to the cooling concept according to the disclosure for such optical elements. In the following, an “optical element” is to be understood as an EUV collector mirror shell.

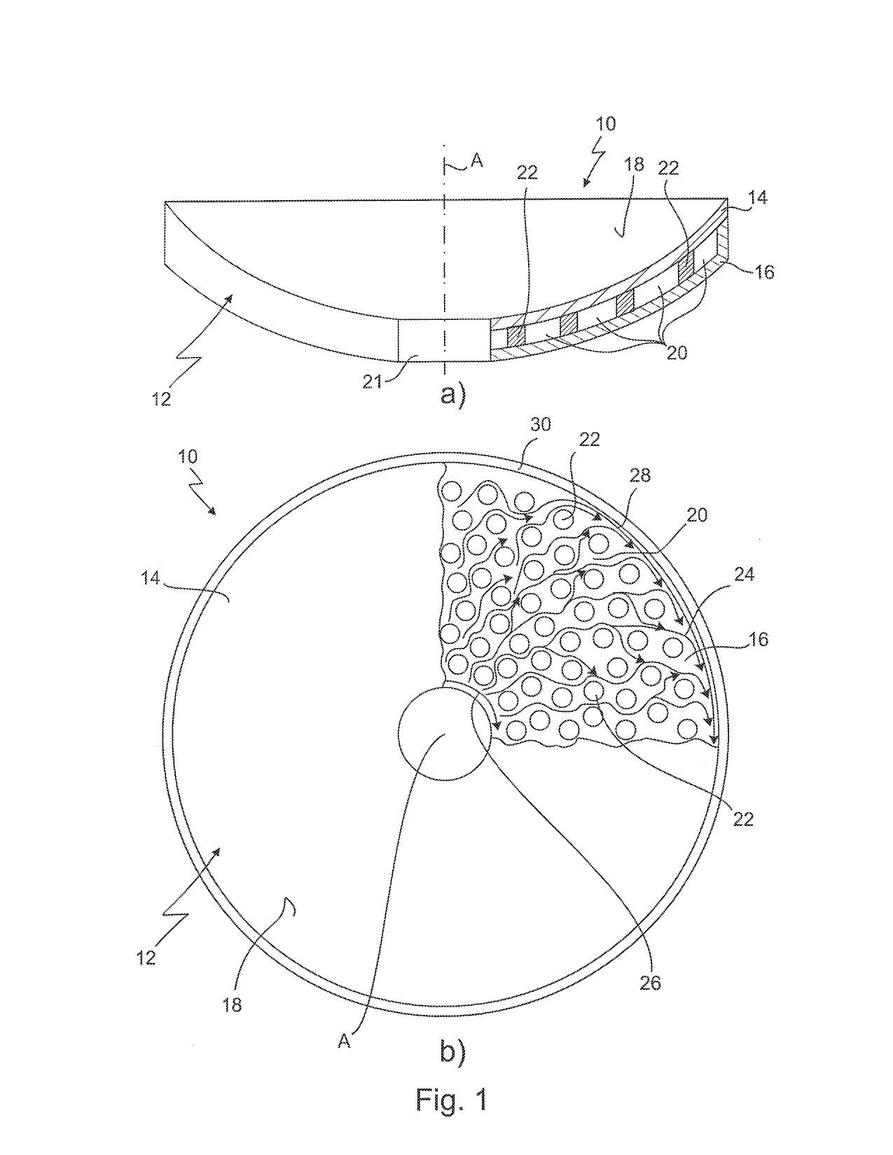

FIG. 1a) and b) show a first exemplary embodiment of an optical element 10. The optical element 10 has a body 12 which has a light incidence-side front part 14 and a rear part 16. The front part 14 has an optically active area 18. The front part 14 may be a substrate, to the light incidence side of which a coating is applied, for example a highly reflecting coating, such as is conventionally used in mirrors.

When the optical element is in use in an optical system, not illustrated, the optically active area 18 is the area onto which light is incident when the optical system is in operation. This light is partially absorbed in the optically active area or in the front part 14 (substrate), with the result that the optically active area 18 or the front part 14 may heat up considerably. In order to avoid or at least reduce damage, deformations and/or impairments of the optical capacity of the optical element 10, the optical element 10 is therefore cooled during operation.

For this purpose, the optical element 10 has between the front part 14 and the rear part 16 a cavity 20 which extends essentially along the entire optically area 18. In other words, the cavity 20 extends essentially over the entire rear side of the front part 14, preferably at a short distance from the optically active area 18. The cavity 20 serves for receiving a cooling medium, for example a liquid or a gas, which can dissipate the heat generated as a result of light absorption from the optical element 10. At least one inlet and at least one outlet are provided for the supply and discharge of the cooling medium, various arrangements of such inlets and outlets being described only with reference to the following figures. The inlets and outlets are not illustrated in the optical element in FIG. 1a) and b).

A plurality of flow-influencing elements 22 are arranged, distributed, in the cavity 20. The flow-influencing elements 22 extend from the front part 14 to the rear part 16 and connect the front part 14 to the rear part 16 and are formed in one piece with the front part 14 and the rear part 16. The same holds for the further embodiments still to be described below.

The flow-influencing elements 22 in this case fulfil two functions. On the one hand, they force the cooling medium flowing in the cavity 20 to flow uniformly through the cavity 20, in that the cooling medium constantly impinges onto a flow-influencing element 22 and the flow is thereby deflected at many local points and in many directions. This avoids the situation where regions of weaker flow and regions of stronger flow are formed in the cavity 20 and may cause thermal gradients in the cooling medium and therefore thermal gradients in the optical element 10, particularly in the optically active area 18. On the other hand, the flow-influencing elements 22, because they connect the front part 14 to the rear part 16, prevent or reduce distortions of the optical element 10 and therefore, in particular, of the optically active area 18 due to the pressure of the cooling medium in the cavity 20. The flow-influencing elements 22 consequently contribute to increasing the dimensional stability of the optical element 10 against mechanical influences, such as, for example, the pressure of the cooling medium.

The flow-influencing elements 22 are designed in the form of posts or pins of small cross section (in drawing plane in FIG. 1b)). The posts may be hollow or solid. The flow-influencing elements 22 themselves preferably have good heat conductivity.

The many individual flow-influencing elements 22 are illustrated in FIG. 1b) in simplified form in the shape of small cycles, the cross-sectional shapes of the flow-influencing elements 22 also being described later.

The flow of the cooling medium is illustrated in FIG. 1b) by a plurality of flow arrows 24, in order to make clear that the flow of the cleaning medium is distributed essentially uniformly throughout the cavity 20.

The distribution of the flow-influencing elements 22 in the cavity 20 is selected as a function of the position of the at least one inlet and the position of the at least one outlet such that the cooling medium flows essentially uniformly through the entire cavity 20. Various distributions and arrangements of the at least one inlet and of the at least one outlet are also described later with reference to further figures. In the exemplary embodiment in FIG. 1a) and b), it is made clear in FIG. 1b), by arrows 26 in the region of the middle of the cavity 20 and 28 at an outer margin 30 of the cavity 20, that the flow of the cooling medium can be propagated azimuthally (with respect to the axis A) in the region of the middle of the cavity 20 and in the region of the outer margin 30 of the cavity. If the at least one inlet for the cooling medium is arranged in the region of the middle and the at least one outlet for the cooling medium is arranged in the region of the outer margin 30, the region of the middle of the cavity 20 acts virtually as a distributor of the cooling medium and the region of the outer margin 30 of the cavity 20 as a collector for the cooling medium. Between the region of the middle of the cavity 20 and the region of the outer margin 30 of the cavity 20, the flow is routed essentially from the middle outwards, and, in the special case of an optical element 20 which is circular with respect to the axis A, essentially radially outward.

In principle, it is possible, in the exemplary embodiment in FIG. 1a) and b), to provide only one inlet orifice and only one outlet orifice, although a larger number of inlets and outlets may possibly be more advantageous.

In a middle 21 of the body 12, the latter has no cavity through which the cooling medium can flow or which can be filled with cooling medium.

The size, shape and density of the flow-influencing elements 22 should be designed in such a way, for example via numerical methods, that the Reynolds' numbers in optical element 10, that is to say in the cavity 20, are identical everywhere, or that the flow of cooling medium is adapted to different capacity distributions, with the aim of as constant a temperature as possible on the optically active area 18, or else with the aim of deforming the optically active surface 18 deliberately, if this is expedient.

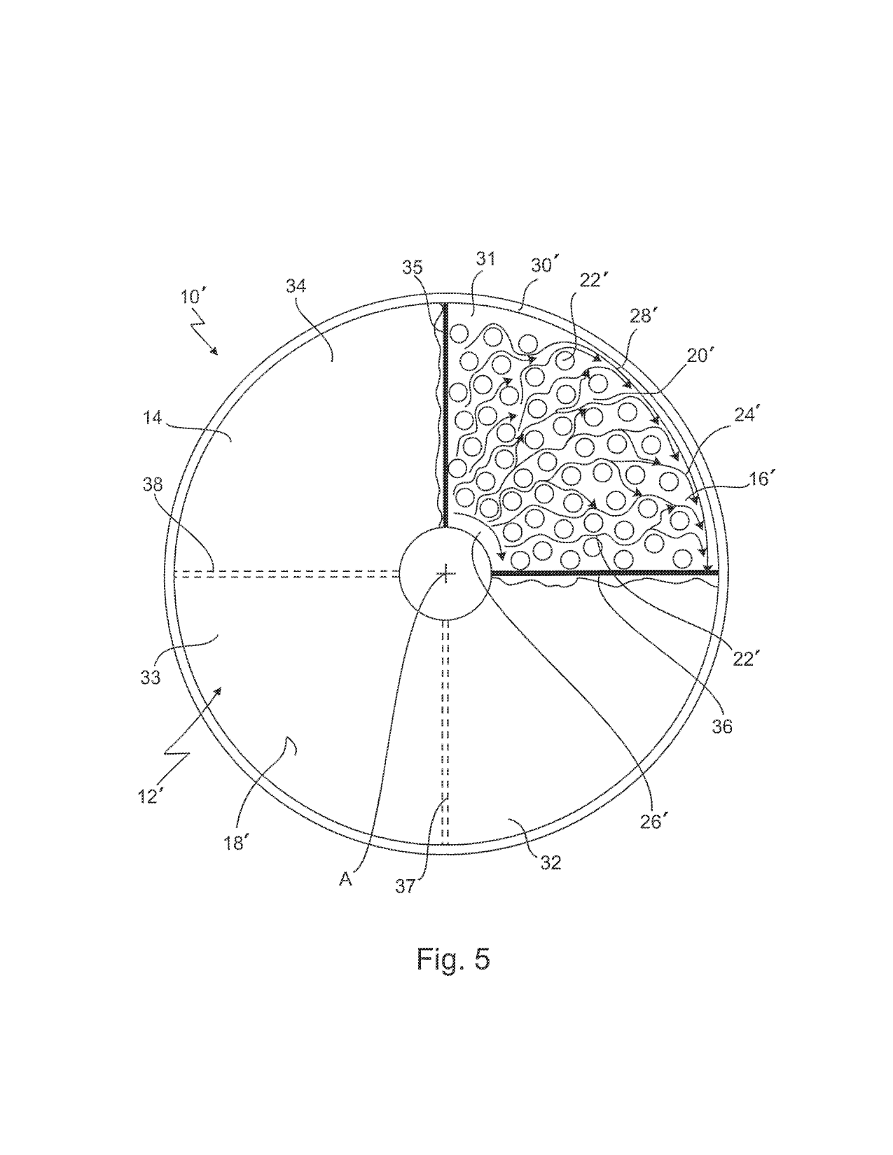

FIG. 5 illustrates an optical element 10′ which is a modification of the optical element 10 in FIG. 1. In the optical element 10′, parts or elements which are identical or similar to parts or elements of the optical element 10 have been given the same reference symbols as the parts or elements of the optical element 10, plus an ′.

The optical element 10′ has a body 12′ with a front part 14′ and with a rear part 16′, the front part 14′ having an optically active area 18′. A cavity 20′ for the throughflow of a cooling medium is present between the front part 14′ and the rear part 16′, and, once again, flow-influencing elements 22′ are likewise arranged in the cavity 20′.

Whereas the cavity 20 of the optical element 10 between the front part 14 and the rear part 16 is formed continuously, the cavity 20′ of the optical element 10′ is subdivided into a plurality of segments, here four segments 31, 32, 33 and 34. For this purpose, a corresponding number of webs, here four webs 35, 36, 37 and 38, extend between the front part 14′ and the rear part 16′. Intermixing of the cooling medium between different segments 31, 32, 33 and 34 does not take place, but, instead, the cooling medium flows separately through each of the segments 31, 32, 33, 34 of the cavity 20′. Each segment 31, 32, 33 and 34 has correspondingly at least one inlet and one outlet for the cooling medium, which are not illustrated in detail here. The webs or partitions 35, 36, 37 and 38 extend in each case between the front part 14′ and the rear part 16′.

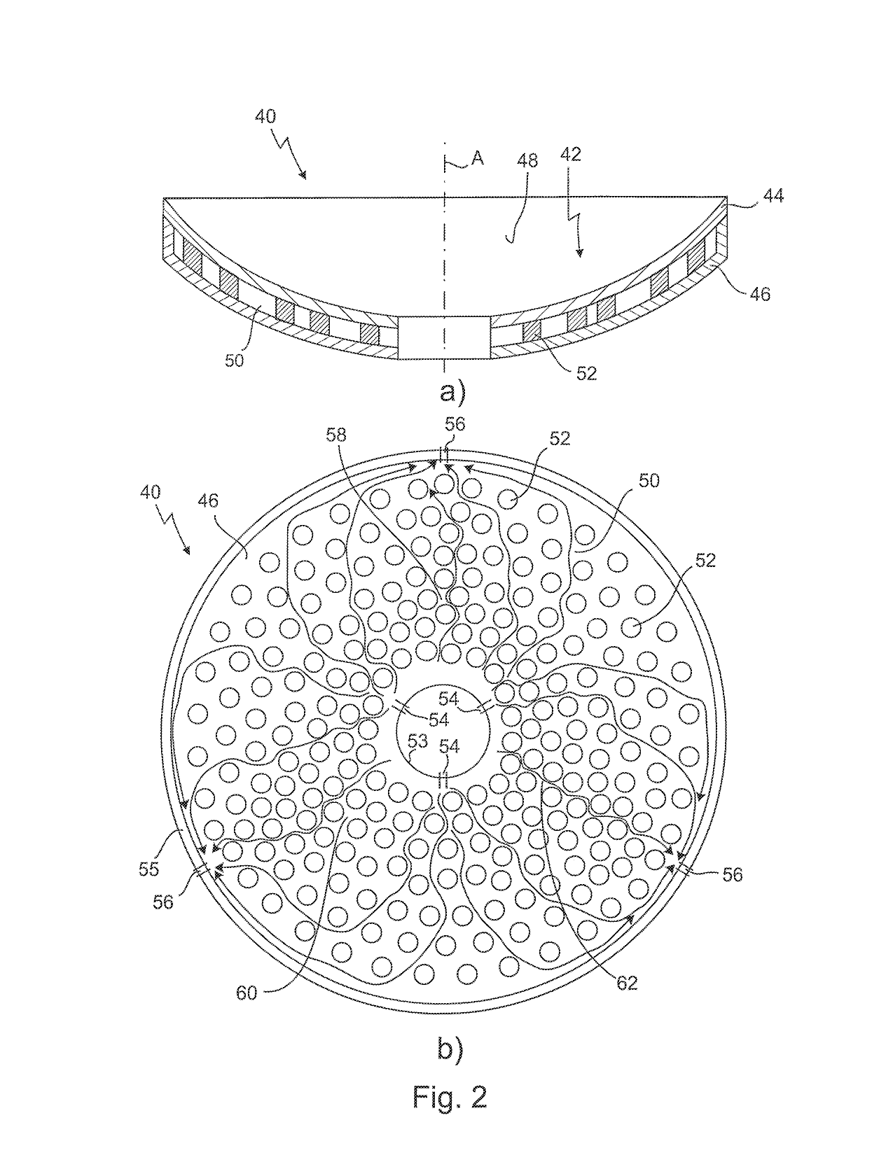

FIG. 2a) and b) illustrate a further exemplary embodiment of an optical element 40. The optical element 40 has a body 42 with a front part 44 and with a rear part 46 and an optically active area 48 and also with a cavity 50 between the front part 44 and the rear part 46, in which cavity is arranged a plurality of flow-influencing elements 52 which connect the front part 44 to the rear part 46 and are arranged, distributed, in the cavity. The flow-influencing elements 52 are illustrated in simplified form as circles in FIG. 2b).

Furthermore, the body 42 has in the region of a middle of the cavity 50, more precisely at an inner margin 53 facing the middle of the body 42, three uniformly distributed inlets 54 for the cooling medium and, in the region of an outer margin 55 which faces away from the middle of the body 42, three circumferentially distributed outlets 56 for the cooling medium.

FIG. 2b) illustrates diagrammatically that a density of the flow-influencing elements 52 in a respective region 58, 60 and 62 in which the in each case shortest path from the inlets 54 to the outlets 56 lies is greater than in the remaining region of the cavity 50. For this purpose, the flow-influencing elements 52 are arranged at a shorter distance from one another in the regions 58, 60 and 62 than in the remaining regions of the cavity 50. The cooling medium is thereby forced to flow through the entire cavity 50 and not to follow the shortest path from the inlets 54 to the outlets 56.

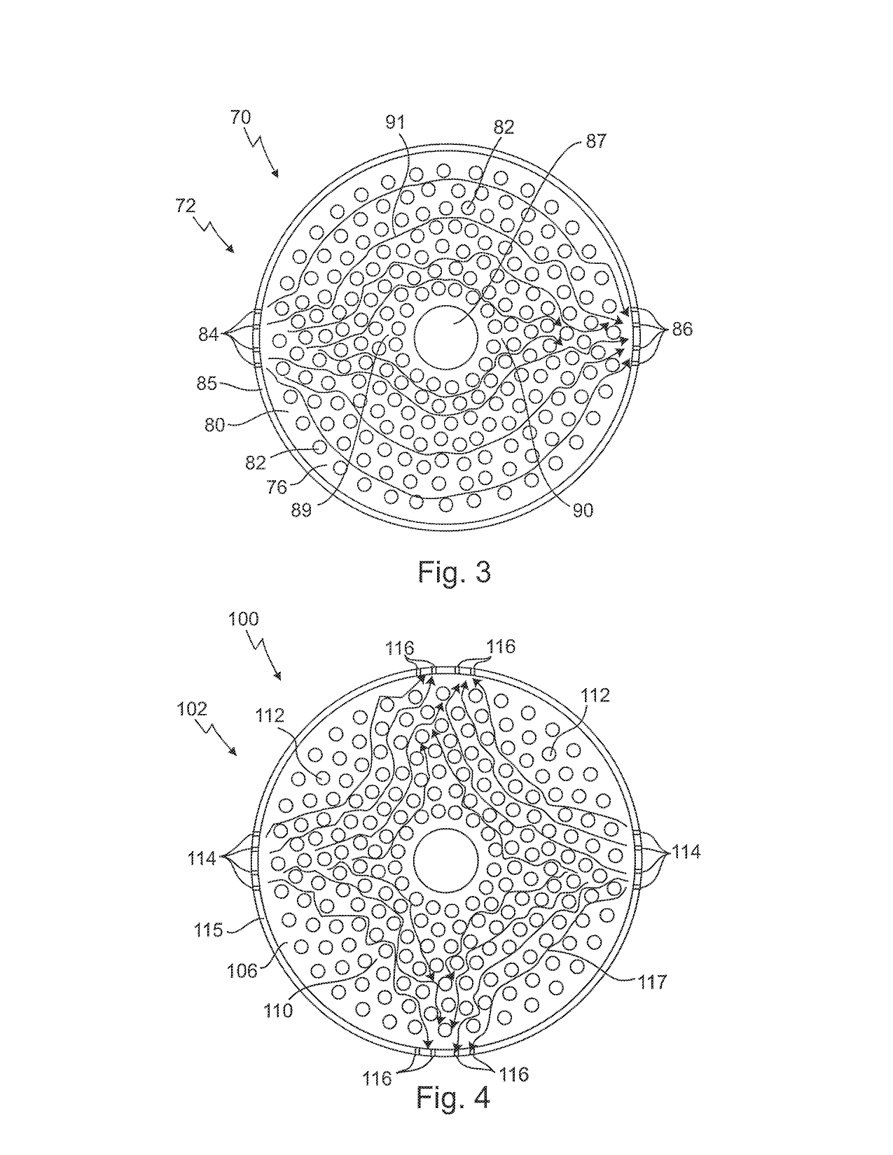

FIG. 3 illustrates a further exemplary embodiment of an optical element 70 with a body 72, a front part of the body 72 being omitted in FIG. 3, so that only a rear part 76 of the body 72 is illustrated in FIG. 3. A cavity 80 through which the cooling medium can flow, is located once again between the front part, not illustrated, and the rear part 76. A plurality of flow-influencing elements 82, which are illustrated in simplified form as circles in FIG. 3, are arranged, distributed, in the cavity.

In the optical element 70, both inlets 84 and outlets 86 are arranged at an outer margin 85, that is to say on the periphery of the body 72 of the optical element 70. In this case, the inlets 84 and the outlets 86 are arranged so as to face one another or be opposite one another with respect to a middle 87 of the body 72 and, in the case of a body 72 which is round, as here, are arranged diametrically opposite one another. The cooling medium flows through the cavity 80 proceeding from the inlets 84 to the outlets 86, and the flow of cooling medium is distributed essentially uniformly by the flow-influencing elements 82 in the cavity 80. The cooling medium flows to a lesser extent only through regions 89 and 90 of the cavity 80, as illustrated by flow arrows 91. However, the regions 89 and 90 of weaker flow may be reduced by a corresponding adaptation of the density of the flow-influencing elements 82 in the cavity 80, in order to bring about an even more uniform distribution of the flow of cooling medium in the entire cavity 80.

FIG. 4 shows a further exemplary embodiment of an optical element 100 in an illustration comparable to the illustration in FIG. 3.

The optical element 100 has a body 102, of which only a rear part 106 is shown in FIG. 4, while a front part is omitted, so that a cavity 110 and, distributed in it, a plurality of flow-influencing elements 112 can be seen in FIG. 4.

As in the exemplary embodiment in FIG. 3, inlets 114 and outlets 116 for a cooling medium are arranged at an outer margin 115 of the body 102. In contrast to the arrangement of the inlets 84 and 86 in FIG. 3, however, the inlets 114 are in each case assigned outlets arranged in positions at the outer margin 115 of the cavity 110 which are not opposite to the position of the inlets 114, but instead are arranged, for example, so as to be offset at 90° with respect to the inlets 114, as here.

Flow arrows 117 show the flow of the cooling medium from the inlets 114 to the outlets 116.

It will be appreciated that the number of inlets and outlets is not restricted to the illustrated number of four inlet 84 and four outlets 86 in FIG. 3 or eight inlets 114 and eight outlets 116 in FIG. 4, but that a smaller or larger number of inlets and outlets may also be envisaged, and in that the inlets or outlets may also be arranged in the region of the middle of the body of the respective optical elements, as illustrated, for example in FIG. 2.

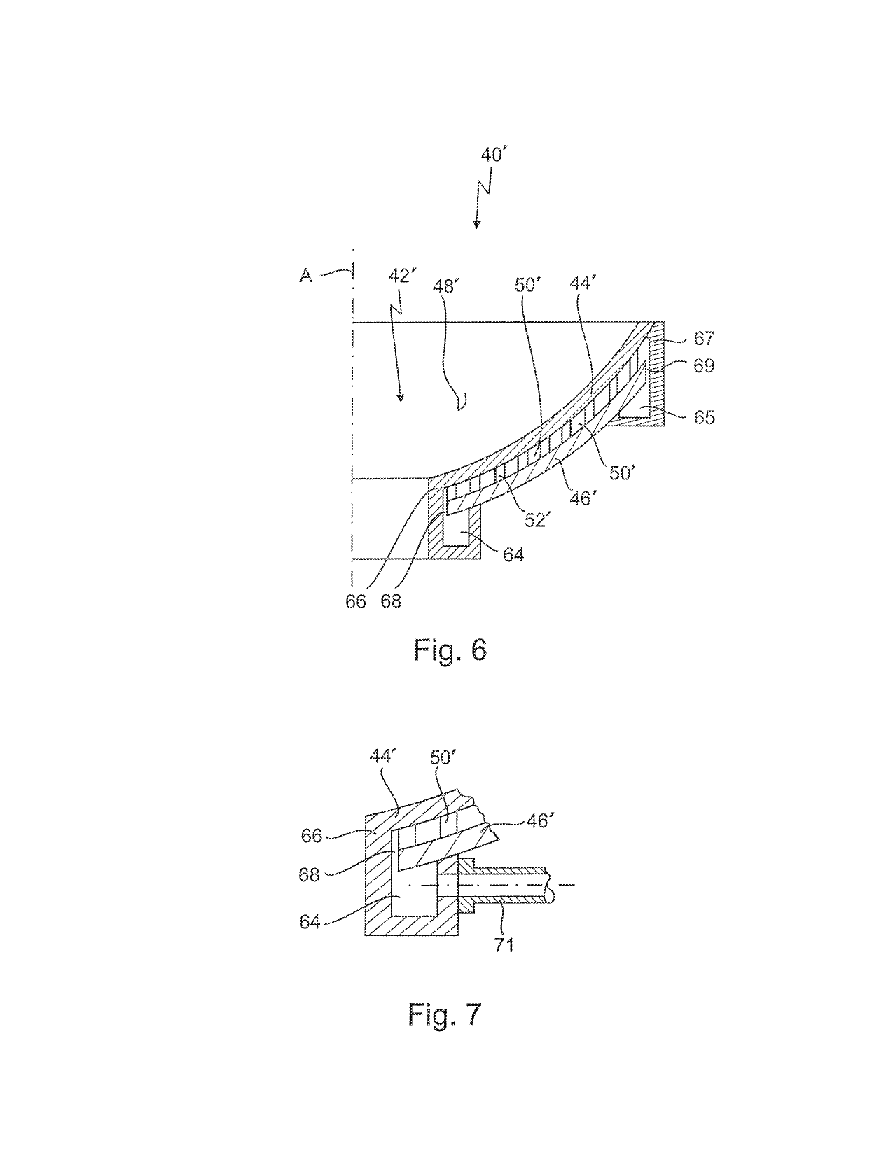

FIG. 6 shows, as a detail, an optical element 40′ which is a modification of the optical element 40 in FIG. 2a) and b). Those parts and elements of the optical element 40′ which are identical or comparable to those of the optical element 40 are given the same reference symbols, plus an ′.

The optical element 40′ has a body 42′, a front part 44′ with an optically active area 48′, a rear part 46′ and a cavity 50′ between the front part 44′ and the rear part 46′, the the cavity extending once again essentially along the entire optically active area 48′.

The difference between the optical element 40′ and the optical element 40 is that the optical element 40′ has an inlet distributor duct 64 and an outlet distributor duct 65. While, in the exemplary embodiments shown, the inlet distributor duct 64 is arranged here at a margin 66, facing the middle of the body 42′ defined by the longitudinal axis A, of the cavity 50′, and the outlet distributor duct 65 is arranged at an outer margin 67 facing away from the middle of the body 42′, an interchanged arrangement of the inlet distributor duct 64 and of the outlet distributor duct 65 may also be selected.

According to FIG. 7, the inlet distributor duct 64 is assigned an inlet connection 71 for the inlet of cooling medium into the inlet distributor duct 64. A corresponding outlet connection, not illustrated here, for the outflow of cooling medium from the outlet distributor duct 65 is likewise provided.

The inlet distributor duct 64 extends about the longitudinal axis A of the optical element 40′, for example by less than 360° or even up to 360°, that is to say, in this case, forms a ring duct, or, according to the exemplary embodiment in FIG. 5, the inlet distributor duct 64 has a plurality of segments which are separated from one another. The cooling medium entering flows in the inlet distributor duct 64 in the azimuthal direction with respect to the longitudinal axis A. The inlet distributor duct 64 opens out into the cavity 50′, via a narrow gap 68, the gap 68 ensuring an azimuthally uniform throughflow of the cavity 50′ in that the cooling medium is built up in the inlet distributor duct 64. The same applies to the outlet distributor duct 65 which opens out into the cavity 50′ likewise via a narrow gap 69. Here, too, an azimuthal flow direction of the cooling medium is brought about.

The gap 68 may extend over the extent of the inlet distributor duct 64 about the longitudinal axis A, or the gap 68 may be replaced by a multiplicity of individual small orifices. The same applies to the gap 69 of the outlet distributor duct 65.

Both the inlet distributor duct 64 and the outlet distributor duct 65 are arranged on a side of the rear part 46′ which faces away from the cavity 50′.

Furthermore, there may be provision for the inlet distributor duct 64 and the outlet distributor duct 65 not to have a uniform cross section over their extent, but instead a cross section tapering from the inlet (inlet connection 68 in FIG. 7). If the inlet connection 68 makes it possible that the cooling medium, when it enters the inlet distributor duct 64, can flow on both sides of the inlet connection 68, that is to say on both sides perpendicularly to the drawing plane in FIG. 7, the inlet distributor duct 64 tapers correspondingly in these two directions, starting from the inlet connection 68, otherwise the inlet distributor duct 64 decreases in only one direction, starting from the inlet connection 68.

A cross-sectional shape likewise tapering in cross section may be provided in the case of the outlet distributor duct 65.

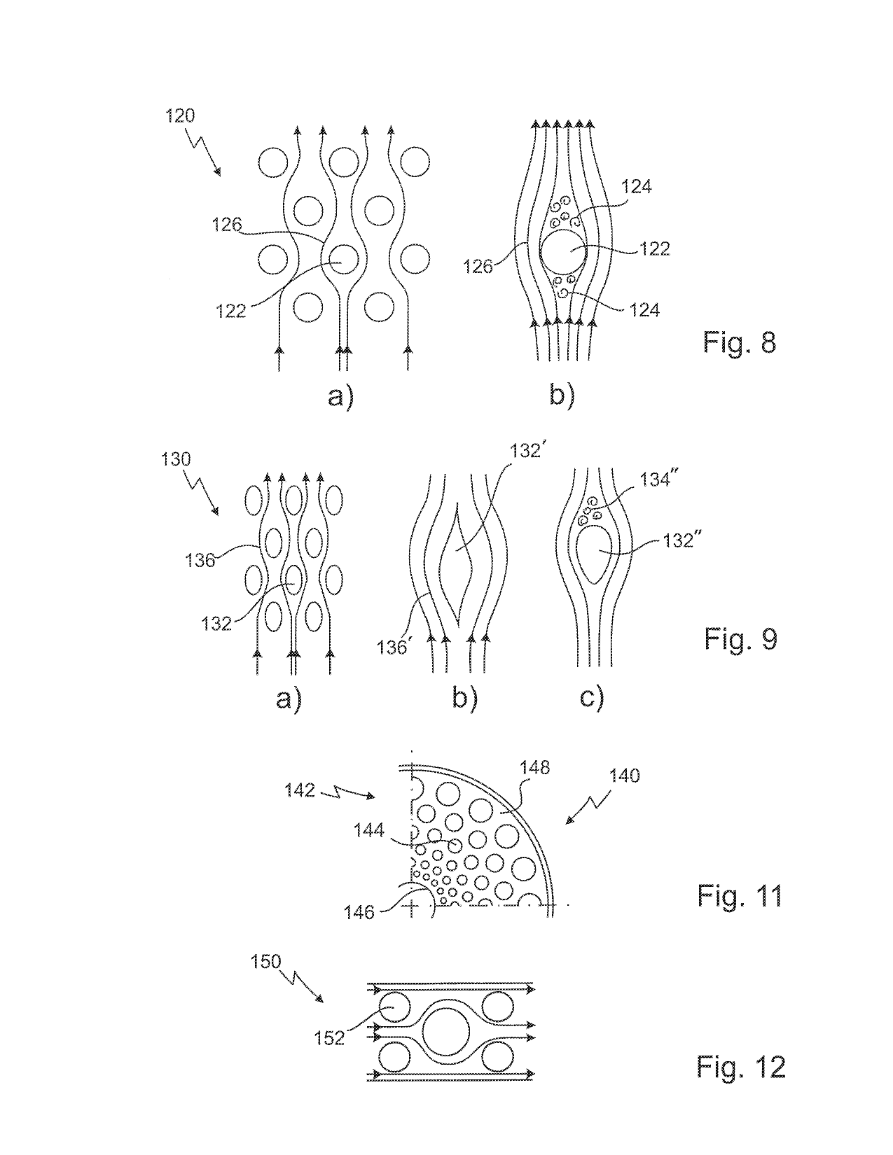

With reference to the further FIGS. 8 to 12, further details regarding the cross-sectional shape of the flow-influencing elements are described. The flow-influencing elements to be described below may be used as the flow-influencing elements 22, 22′, 52, 52′, 82 or 112 in each of the optical elements according to FIGS. 1 to 7.

FIG. 8a) shows a detail from an arrangement 120 of flow-influencing elements 122. The flow-influencing elements 122 have, in the cross section illustrated, a shape which causes eddying of the flow of cooling medium, as illustrated in FIG. 8b) by individual eddies 124, showing the flow conditions at a single flow-influencing element 122. In FIG. 8a) and b), the flow of the cooling medium is indicated by flow arrows 126. In the exemplary embodiment in FIG. 8, the flow-influencing elements 122 are round or circular in cross section, in such a way that the eddying of the flow of cooling medium occurs both on the upstream side and on the downstream side of the flow-influencing elements 122. The basic flow of cooling medium may in this case be laminar or in the laminar-to-turbulent transitional region (Reynolds' number below 10,000). The eddying of the flow of cooling medium by the flow-influencing elements 122 brings about good heat dissipation, but may sometimes lead to a higher pressure loss in the flow of cooling medium and also to the excitation of vibrations in the optical element.

FIG. 9a) shows a further detail from an arrangement 130 of flow-influencing elements 132. Moreover, flow arrows 136 illustrating the local flow direction of the cooling medium are depicted in FIG. 9a).

In contrast to the flow-influencing elements 122 in FIG. 8, the flow-influencing elements 132 have in cross section a shape which causes less eddying or no eddying in the flow of cooling medium. This can be achieved, in general, via a cross-sectional shape of the flow-influencing elements 132 which deviates from a circular shape.

FIG. 9b) shows a special case of a flow-influencing element 132′ which has in cross section a shape which is streamlined, so that no eddies occur when the cooling medium flows past the flow-influencing element 132′. Via such a shape of the flow-influencing elements 132′, pressure losses and vibrations in the optical element due to eddying can be kept as low as possible. However, because of the absence of eddying, heat dissipation is possibly lower here.

FIG. 9c) shows a compromise between good heat dissipation and low pressure loss and low excitation of vibrations, this being achieved via flow-influencing elements 132″ which have in cross section, for example, a drop shape. In this case, eddying occurs only on the downstream side of the flow-influencing elements 132″, whereas the flow remains laminar on the upstream side.

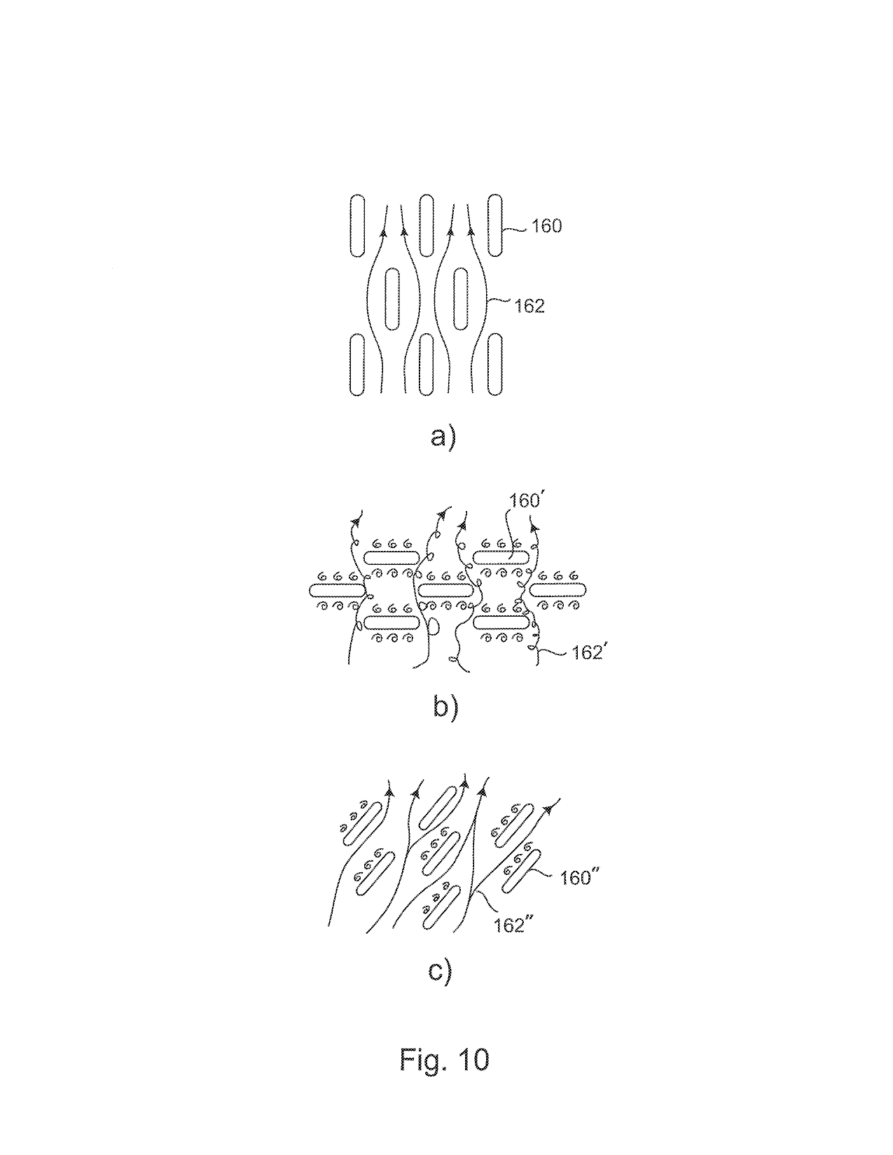

FIG. 10a) to c) show further embodiments and orientations of flow-influencing elements 160, the cross-sectional shape of which is elongate, for example in the form of a flat oval or a rectangle with rounded narrow sides. A curved, elongate cross-sectional shape is also possible. In this refinement, the flow-influencing elements 160 are designed as baffle-shaped posts. In FIG. 10a), the flow-influencing elements 160 are oriented with their longitudinal direction parallel to the flow direction of the cooling medium, the the flow direction being illustrated by flow arrows 162. In this orientation of the flow-influencing elements 160, virtually no eddying occurs, but there is a good routing of the cooling medium.

In the arrangement in FIG. 10b), the flow-influencing elements 160′ are oriented transversally to the flow direction of the cooling medium, that is to say the long sides of the flow-influencing elements 160′ stand approximately perpendicularly to the flow direction of the cooling medium, the the flow direction being illustrated by flow arrows 162′. In this arrangement of the flow-influencing elements 160′, the routing of the cooling medium is reduced and the eddying of the cooling medium with the effect of good heat dissipation is high.

FIG. 10c) shows an arrangement of flow-influencing elements 160″ in which the orientation of the flow-influencing elements 160″ is non-parallel, specifically oblique, with respect to the flow direction of the cooling medium (flow arrows 162″), as a result of which, on the one hand, certain eddying of the cooling medium with the effect of good heat dissipation is achieved, and, on the other hand, the cooling medium is routed through the cavity in a directed way.

FIG. 11 shows, as a detail, a further optical element 140 with an arrangement 142 of flow-influencing elements 144 which are illustrated here as circles, although this is not to be understood as being a restriction to the cross-sectional shape of the flow-influencing elements 144.

FIG. 11 shows that the flow-influencing elements 144 have a variable cross-sectional size. The variation in cross-sectional size is illustrated here from a middle 146 to an outer margin 148 of the body of the optical element 140, in the exemplary embodiment shown the cross-sectional size of the flow-influencing elements 144 increasing from the middle 146 towards the outer margin 148.

Finally, FIG. 12 also shows a detail of a flow region 150 in an optical element which is provided with flow-influencing elements 152 of different sizes in order to bring about good heat dissipation.

In all the exemplary embodiments described above, the flow-influencing elements cause permanent local deflection of the flow of cooling medium, with the result that the latter flows through the respective cavity of the respective optical element as uniformly as possible for the purpose of as optimal a heat dissipation as possible.

The optical elements 10, 40, 70, 100 described above can be manufactured via various production methods. In general, the respective cavity could be incorporated into the respective front part or the respective rear part or into both, and the respective front part and rear part could subsequently be welded or soldered to one another. Adhesive bonding or another connection technique may also be envisaged here.

In general, the body of the respective optical element 10, 40, 70, 100 should be manufactured from a material having good heat conductivity (better than 50 W/mk). In addition to the conventional aluminium alloys, a substrate made from silicon carbide has the advantage of a high modulus of elasticity, along with a very low coefficient of thermal expansion. In this case, the respective front part and respective rear part can be manufactured separately, machined to the desired dimensional accuracy and subsequently connected to one another. Alternatively, the respective front part and respective rear part could be manufactured from an untreated body and processed into SiC via a subsequent silicating process. Aluminium, copper and copper alloys may likewise be used as material.

1. A mirror shell, comprising:
a body including an inlet, an outlet, a front part, a rear part and a cavity between the front and rear parts, the front part including a reflective optically active area, the cavity extending essentially along the entire optically active area, the cavity being in fluid communication with the inlet and the outlet, the cavity being configured to receive a cooling medium, the cavity including a plurality of flow-influencing elements extending from the front part to the rear part and connect the front and rear parts,
wherein the front part, rear part and flow-influencing elements are monolithic, and the mirror shell is an EUV lithography collector mirror shell.

2. The mirror shell of claim 1, wherein a distribution, a size and/or a shape of the flow-influencing elements is based on a position of the inlet and a position of the outlet so, during use of the mirror shell, the cooling medium flows essentially uniformly through the entire cavity

3. The mirror shell of claim 1, wherein:
the inlet is at an inner margin of the cavity which faces a middle of the body, and the outlet is at an outer margin of the cavity which faces away from the middle of the body; or
the outlet is at an inner margin of the cavity which faces the middle of the body, and the inlet is at an outer margin of the cavity which faces away from the middle of the body.

4. The mirror shell of claim 3, wherein a density of a distribution of the flow-influencing elements is higher in a region of the cavity corresponding to a shortest path between the inlet to the outlet than a density of the flow-influencing elements elsewhere in the cavity.

5. The mirror shell of claim 1, wherein the inlet and the outlet are at an outer margin of the cavity which faces away from a middle of the body.

6. The mirror shell of claim 5, wherein the inlet and the outlet are in mutually opposite positions at the outer margin of the cavity.

7. The mirror shell of claim 5, wherein the body includes two outlets, the inlet is assigned the two outlets, and the two outlets are arranged at the outer margin of the cavity in positions which are not opposite to the position of the inlet.

8. The mirror shell of claim 1, wherein the cavity has a region through which the cooling medium does not flow, and the region of the cavity corresponds to a middle of the area of the optically active area.

9. The mirror shell of claim 1, wherein the cavity is subdivided into a plurality of segments which are separated completely from one another by webs which extend from the rear part to the front part, and each segment has at least one inlet and at least one outlet for the cooling medium.

10. The mirror shell of claim 1, wherein:
the inlet opens out into an inlet distributor duct and/or in that the outlet opens out into an outlet distributor duct;
the inlet distributor duct and/or the outlet distributor duct open out into the cavity; and
the inlet distributor duct and/or the outlet distributor duct extend azimuthally with respect to a longitudinal axis running perpendicularly to the optically active area.

11. The mirror shell of claim 10, wherein the inlet distributor duct and/or the outlet distributor duct are/is arranged on a side of the rear part which faces away from the cavity.

12. The mirror shell of claim 10, wherein the inlet distributor duct and/or the outlet distributor duct open out/opens out into the cavity via a narrow gap extending over the length of the inlet distributor duct and/or outlet distributor duct in the azimuthal direction about the longitudinal axis, or via a plurality of small orifices.

13. The mirror shell of claim 10, wherein the cross section of the inlet distributor duct and/or the cross section of the outlet distributor duct change/changes, starting from the inlet or the outlet respectively.

14. The mirror shell of claim 10, wherein the flow-influencing elements have in cross section a shape which causes eddying in the flow of the cooling medium.

15. The mirror shell of claim 1, wherein the flow-influencing elements have in cross section a shape which causes eddying in the flow of the cooling medium.

16. The mirror shell of claim 15, wherein the flow-influencing elements have a cross-sectional shape configured to cause eddying in the flow of the cooling medium only on a side of a respective flow-influencing element which faces away from a local flow direction.

17. The mirror shell of claim 15, wherein the flow-influencing elements are round in cross section and/or have an elongate shape in cross section, and, when the flow-inducing elements have an elongate cross-sectional shape the flow-influencing elements have a longitudinal extent non-parallel with respect to a flow direction of the cooling medium.

18. The mirror shell of claim 15, wherein the flow-influencing elements are drop-shaped in cross section.

19. The mirror shell of claim 1, wherein the flow-influencing elements have in cross section a shape which is streamlined or elongate.

20. The mirror shell of claim 1, wherein the flow-influencing elements have a differing cross-sectional size from a middle toward the outer margin of the cavity.
